(19) United States
(12) Patent Application Publication
(10) Pub. No.: US 2010/0315623 A1
(43) Pub. Date: Dec. 16, 2010

(54) METHOD AND DEVICE FOR MEASURING A FLUX OF A SELECTED INDIVIDUAL LIGHT SOURCE AMONG A PLURALITY OF LIGHT SOURCES

(75) Inventor: Erik Nieuwlands, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/446,480

(22) PCT Filed: Oct. 22, 2007
(86) PCT No.: PCT/IB07/54277

§ 371 Date: Apr. 21, 2009

(30) Foreign Application Priority Data
Oct. 27, 2006 (EP) 06123061.1

(51) Int. Cl. G01J 1/00

(52) U.S. Cl. 356/213

(57) ABSTRACT

The invention provides a method for measuring a flux of a selected individual lightsource among a plurality of lightsources, wherein each lightsource is controlled by an associated pulse width modulated signal, and each pulse width modulated signal has a first logic level interval at a first extremity of a timecycle wherein the associated lightsource is to be lit, and a second level interval during the remainder of said timecycle. The method according to the present invention comprises time inverting the pulse width modulated signal of all lightsources that have a first logic level interval at the same extremity as the first logic level interval as the individual lightsource to be measured (usually this applies for the pulse width modulated signals for all lightsources), by shifting their high level interval to a second extremity of a timecycle and measuring the flux of the selected individual lightsource at the first extremity of the timecycle.

### FIELD OF THE INVENTION

The invention relates in general to measuring a flux of an individual lightsource among a plurality of lightsources, and in particular it relates to measuring a flux of a LED lightsource among a plurality of PWM controlled LED lightsources with various colors.

### BACKGROUND OF THE INVENTION

Light systems for providing a variety of colors usually comprise multiple lightsources, arranged in each other's environment, each lightsource supplying a single color. An observer will experience the light emitted by the lightsources as if it comprises one color. The experienced color depends on the relative intensity of the color of each specific lightsource.

The intensity of a lightsource is also referred to as flux in the art, and it can be controlled by the amount of current that flows through the lightsource. This current often is a pulse width modulated current or another time multiplexed driving, alternating between a first logic level and a second logic level.

Due to influences of for example lifetime or temperature, however, the amount of flux as a function of the lightsource current may vary. For obtaining a desired color of light in an array it is therefore necessary to measure either the resulting color value with a color sensor, or to measure the flux of each individual lightsource. In the latter case, it is desired to measure the flux of a single lightsource, without the influence of the other lightsources. However, when the intensities of the lightsources are pulse width modulated, the individual lightsources usually are all lit at the beginning of a timecycle of the modulation, and turned off at various moments.

Determining the amount of flux output by one single lightsource then becomes difficult, and it can only be performed indirectly, by calculating them on the basis of various measurements.

### OBJECT OF THE INVENTION

It is an object of the present invention to provide a method and device for measuring a flux of a selected individual lightsource among a plurality of lightsources, wherein the flux of said lightsource is determined more easily and more reliably.

### SUMMARY OF THE INVENTION

The invention provides a method for measuring a flux of a selected individual lightsource among a plurality of lightsources, wherein each lightsource is controlled by an associated pulse width modulated signal, and each pulse width modulated signal has a first logic level interval at a first extremity of a timecycle wherein the associated lightsource is to be lit, and a second level interval during the remainder of said timecycle. In general the first level may be a logic high level and the second level may be a logic low level, but negative logic may be applied as well. Furthermore the first extremity of the time interval may in general be the beginning of a timecycle, but it may also be the end thereof. The method according to the present invention comprises time inverting the pulse width modulated signal of all lightsources that have a first logic level interval at the same extremity as the first logic level interval as the individual lightsource to be measured (usually this applies for the pulse width modulated signals for all lightsources), by shifting their high level interval to a second extremity of a timecycle and measuring the flux of the selected individual lightsource at the first extremity of the timecycle. The pulse width modulated signal of the individual lightsource to be measured is not time-shifted, and, if any of the signals not to be measured already has a first logic level at the second extremity of the time interval, the first logic level of that signal will not be time shifted as well. As a result, at the first extremity of a timecycle, e.g. the beginning, after performing the method according to the present invention, all signals associated with lightsources have a second logic level, e.g. a low level, except for the signal of the lightsource of which the flux has to be measured, which has a first logic level, e.g. a high level. It is also possible that for example one of the individual lightsources, when not being measured, is lit at the beginning of a timecycle, and all other individual lightsources are lit at the end of the timecycle, when not measuring, or vice versa. It will be clear that, in such a case, it is not necessary to invert all individual lightsources, but only those that are lit at the same extremity as the one to be measured.

Furthermore it is possible that the pulse width modulated signal of the lightsource to be measured is time-shifted to the end of the timecycle.

A great advantage of the invention is that measuring the flux of an individual lightsource is effectively and in a simple manner decoupled from the other lightsources. Each flux can be measured directly, without having to weight or distract other fluxes. The method and device hence become more reliable and simpler.

The method may further comprise the step of successively selecting a second lightsource and repeating the above mentioned steps, which step may be repeated until all lightsources have been measured. Therein, a problem may arise when a lightsource has a pulse width modulated control signal which is continuously at a first logic level, e.g. a high level. In that case, the step of inverting the pulse width modulating signal does not result in an interval with a second logic level pulse width modulation signal at a first extremity of the timecycle. The method according to the present invention therefore may comprise the step of limiting a first logical level interval of a lightsource of which the first logical level interval covers the full timecycle, for an amount of time. This step enables measuring a flux of a selected individual lightsource among a plurality of lightsources, while at least one of the lightsources has a full duty cycle. Usually, the first logical level is limited for a very short amount of time only, for example between 0 to 1 percent of the timecycle. Such an interval may be long enough to perform a measurement, while the difference in the flux is so small that it will not be noticed by a spectator.

The method according to the present invention may further comprise the steps of limiting a first logic level interval of all lightsources at the beginning of a timecycle and measuring a flux at the first extremity of said timecycle for reducing the influence of environmental noise, by subtracting a measured value in the absence from light from measured values with a lightsource.

The inverting of the pulse width modulation signal may be performed by subtracting an inverted pulse width modulating signal with a complementary duty cycle from a high level value. This step may especially be advantageous when utilizing a commonly available pulse width modulation device as a part of a device for performing the method according the present invention, since commonly available pulse width modulation devices are in general not capable of inverting the pulse width modulated signal in the above mentioned way.

The method according to the present invention may further comprise repeating any step or measurement, for reasons of accuracy.

The invention further relates to a device for performing said method, and in particular provides a device for measuring a flux of a selected individual lightsource among a plurality of lightsources, wherein:
each lightsource is controlled by a respective pulse width modulated signal;
each pulse width modulated signal is switchable between a first logic level and a second logic level;
each pulse width modulated signal has a first logic level during a first interval at a first extremity of a timecycle during which the associated lightsource is to be lit, and a second logic level during a second interval during the remainder of the timecycle;
   the device comprising:
means for determining the extremity among the first extremity and the second extremity at which the selected lightsource has the first interval at the first logic level during the time cycle;
means for time inverting the pulse width modulated signal of all lightsources having a first interval at a first logic level at the determined extremity, except for the individual lightsource to be measured, by shifting the first logic level interval to the second extremity of the timecycle;
   means for measuring the flux of the selected individual lightsource at the first extremity of the timecycle. The device may comprise a sensor, and a microcontroller.

Furthermore the invention relates to such device, provided with at least two lightsources.

In a practical embodiment, at least a lightsource may comprise a LED, and in general a plurality of lightsources comprise LED's, e.g. of which each LED generates a different color of light.

The invention will be elucidated below with reference to the accompanying drawings.

### BRIEF DESCRIPTION OF THE DRAWINGS

FIG. 1a shows a graph of pulse width modulated signals for controlling lightsources according to the state of the art;

FIG. 1b shows a graph of pulse width modulated signals provided by a method according to the present invention;

FIG. 2a shows a graph of pulse width modulated signals of which two signals have a full-duty cycle;

FIG. 2b shows a graph of pulse width modulated signals of FIG. 2a, of which said two signals have a second logic level during a first interval.

### DETAILED DESCRIPTION OF EXAMPLES

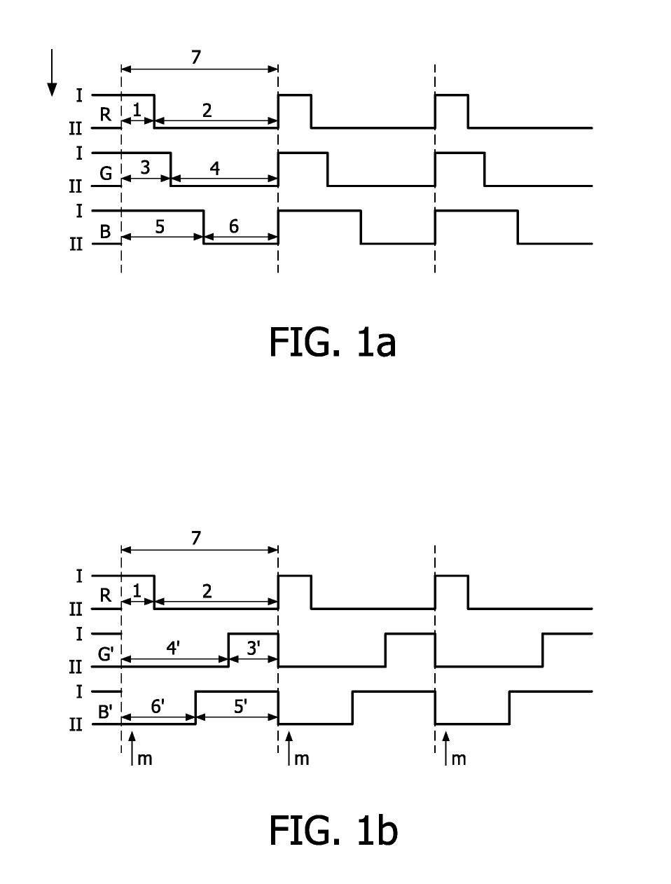

FIG. 1a shows a graph of three pulse width modulated signals R, G, B for controlling lightsources according to the state of the art. The pulse width modulation has a timecycle 7. The first signal R has a first logic level I during a first interval 1 and a second logic level II during a second interval 2. The second signal G has a first logic level I during a first interval 3 and a second logic level II during a second interval 4. The third signal R has a first logic level I during a first interval 5 and a second logic level II during a second interval 6. The first intervals 3, 5 of the second signal G and the third signal B are overlapping the first interval 1 of the first signal R, so it is not possible to measure only the presence of signal R.

FIG. 1b shows a graph of three pulse width modulated signals R, G′, B′ from FIG. 1a for controlling lightsources, treated with the method according to the present invention. The first signal R is the signal of which the flux is to be measured, which is unaltered in comparison with the first signal R of FIG. 1a.

The second signal G′ is derived from the second signal G from FIG. 1a by inverting the pulse width modulation thereof. The first logic level I interval 3 of second signal G has been shifted from a first extremity A (i.e. the beginning) of the timecycle 7 to a second extremity B (i.e. the end) of the timecycle 7 to become the first logic level I interval 3′ of the second signal G′. The second logic level II interval 4 of the second signal G has been shifted to the first extremity A (i.e. the beginning) of the timecycle 7 to become the second logic level I interval 4′ of the second signal G′.

The third signal B′ is derived from the third signal B from FIG. 1a by inverting the pulse width modulation thereof. The first logic level I interval 5 of second signal B has been shifted from a first extremity A (i.e. the beginning) of the timecycle 7 to a second extremity B (i.e. the end) of the timecycle 7 to become the first logic level I interval 5′ of the second signal B′. The second logic level II interval 6 of the second signal B has been shifted to the first extremity A (i.e. the beginning) of the timecycle 7 to become the second logic level I interval 6′ of the second signal B′.

The arrows m indicate a point near the first extremity A of the timecycle 7 wherein only the first signal R has a first logic level I value, and the second signal G′ and the third signal B′ both have a second logic level value. At these points, in general, a measurement of the flux of a lightsource controlled by the first signal can be made, without the influence of other lightsources among the plurality of lightsources.

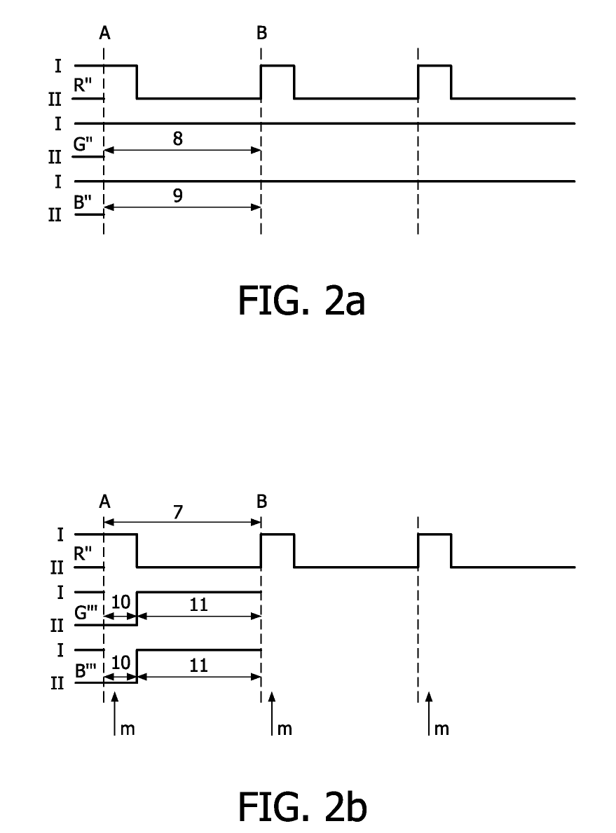

FIG. 2a shows a graph with three pulse width modulated signals R″, B″, G″, wherein the second signal G″ and the third signal B″ have a full-duty cycle, i.e. the second signal G″ and the third signal B″ have a first logic value I interval 8 and a first logic level I interval 9 respectively during the entire timecycle 7. In this case, inverting the time signal does not provide an interval in which the first signal R″ has a first logic level, and the second signal G″ and the third signal B″ have a second logic level. The present invention provides a solution to this problem by limiting a first logical level interval of a lightsource at a first extremity A of the timecycle 7 or at the second extremity B of the timecycle 7.

FIG. 2b shows the three pulse width modulated signals R″, G′ and B′″. The first pulse width modulated signal R″ is unaltered in comparison with FIG. 2a, having a first logic level I interval 10 and a second logic value II interval 11, during a timecycle 7. The second signal G′″ has a second logic level II interval 10 at the first extremity A of the time cycle 7, and a first logic level I during the remainder of the time cycle 7. The third signal B′″ also has a second logic level II interval 10 at the first extremity A of the time cycle 7, and a first logic level I during the remainder of the time cycle 7. This enables the measurement of the flux of a lightsource which is controlled by the first signal R″. In case the first signal R″ also has a full duty cycle, the first interval 10 can also be selected at the second extremity B of the time cycle 7.

A device for performing the above mentioned method may comprise at least a sensor for sensing the flux and a micro controller for generating at least a pulse width modulation signal. The device may also comprise at least a lightsource, such as a LED.

As required, a detailed embodiment of the present invention is disclosed herein, and it is to be understood that the disclosed embodiment is merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term high level, as used herein, is defined as positive logic (i.e. high voltage or signal level), although it will be clear to those skilled in the art that negative logic may be applied as well.

1. Method for measuring a flux of a selected individual lightsource among a plurality of lightsources, wherein:
each lightsource is controlled by a respective pulse width modulated signal;
each pulse width modulated signal switches between a first logic level and a second logic level;
each pulse width modulated signal has a first logic level during a first interval at a first extremity of a timecycle during which the associated lightsource is to be lit, and a second logic level during a second interval during the remainder of the timecycle;
the method comprising the steps of:
determining the extremity among the first extremity and the second extremity at which the selected lightsource has the first interval at the first logic level during the time cycle;
time inverting the pulse width modulated signal of all lightsources having a first interval at a first logic level at the determined extremity, except for the individual lightsource to be measured, by shifting the first logic level interval to the second extremity of the timecycle;
measuring the flux of the selected individual lightsource at the first extremity of the timecycle.

2. Method according to claim 1, further comprising the step of:
time inverting the pulse width modulated signal of the selected lightsource, prior to the step of time inverting the pulse width modulated signal of all lightsources having a first interval at a first logic level at the determined extremity.

3. Method according to claim 1, further comprising:
successively selecting a second lightsource and repeating the steps of claim 1.

4. Method according to claim 1, further comprising:
limiting a first interval at a first logic level of a lightsource of which the first interval at the first logic level covers the full timecycle.

5. Method according to claim 4, wherein the limiting covers between 0 to 1 percent of the timecycle.

6. Method according to claim 1, further comprising the steps of:
limiting a first logic level interval of all lightsources at the beginning of a timecycle.
measuring a flux at the first extremity of said timecycle for reducing the influence of environmental noise.

7. Method according to claim 1, wherein inverting of the pulse width modulated signal is performed by subtracting an inverted pulse width modulated signal with a complementary duty cycle from a high level.

8. Method according to claim 1, wherein at least a lightsource comprises a LED.

9. Method according to claim 8, wherein a plurality of lightsources comprises LED's.

10. Method according to claim 9, wherein at least a first LED and a second LED among the plurality of LED's generate a different color of light.

11. Method according to claim 1, wherein the measured flux of the lightsource is used to control the pulse width modulation of at least a lightsource.

12. Device for measuring a flux of a selected individual lightsource among a plurality of lightsources, wherein:
each lightsource is controlled by a respective pulse width modulated signal;
each pulse width modulated signal is switchable between a first logic level and a second logic level;
each pulse width modulated signal has a first logic level during a first interval at a first extremity of a timecycle during which the associated lightsource is to be lit, and a second logic level during a second interval during the remainder of the timecycle;
the device comprising:
means for determining the extremity among the first extremity and the second extremity at which the selected lightsource has the first interval at the first logic level during the time cycle;
means for time inverting the pulse width modulated signal of all lightsources having a first interval at a first logic level at the determined extremity, except for the individual lightsource to be measured, by shifting the first logic level interval to the second extremity of the timecycle;
means for measuring the flux of the selected individual lightsource at the first extremity of the timecycle.

13. Device according to claim 12, further comprising:
a sensor for sensing the flux;
a micro controller for generating at least a pulse width modulation signal.

14. Device according to claim 13, further comprising at least two lightsources.

15. Device according to claim 14, wherein at least one lightsource comprises an LED.
